(19) United States
(12) Patent Application Publication
(10) Pub. No.: US 2012/0067234 A1
(43) Pub. Date: Mar. 22, 2012

(54) ARRANGEMENT AND METHOD FOR CONTROLLING A SPRAY OUTLINE FROM A SPRAY ASSEMBLY AT A PRINTING PRESS

(75) Inventor: Birger Hansson, Akarp (SE)

(73) Assignee: BALDWIN JIMEK AB, Arlov (SE)

(21) Appl. No.: 13/258,711

(22) PCT Filed: Mar. 31, 2010
(86) PCT No.: PCT/EP10/54353

§ 371 Date: Dec. 7, 2011

(30) Foreign Application Priority Data
Mar. 31, 2009 (SE) 0950203-0

(51) Int. Cl. B41F 1/46

(52) U.S. Cl. 101/363

(57) ABSTRACT

An arrangement for controlling a spray distribution of a pulse width modulated spray dampener at a printing press comprises a spray beam (110), a number of spray units (120) fastened to the spray beam, and a housing (300) at least partly enclosing the spray units. The housing is arranged such that at least a part of the sprays emitted from the spray units (120) is screened off from escaping the housing, and an individually formed screen surface (130) is configured to control the spray distribution by screening off spray portions from escaping the housing.

### FIELD OF THE INVENTION

The present invention relates to an arrangement for controlling a spray distribution of a pulse width modulated spray dampener at a printing press. The arrangement comprises a spray beam, a number of spray units fastened to the spray beam, and a housing at least partly enclosing the spray units. The housing is arranged such that at least a part of the sprays emitted from the spray units is screened off from escaping the housing.

The invention also relates to a method for controlling a spray distribution of a pulse width modulated spray dampener at a printing press. The dampener comprises a spray beam, a number of spray units fastened to the spray beam, and a housing that at least partly encloses the spray units. The housing is arranged such that at least a part of the sprays emitted from the spray units is screened off from escaping the housing.

### PRIOR ART

In the art of offset printing, it is necessary to provide a printing cylinder with a fountain solution, i.e. a water based solution; since the offset printing process relies on the affinity difference between ink and fountain solution.

There are mainly two methods used to provide the fountain solution to the printing cylinder, namely spraying onto the printing cylinder, or roll transferring of the fountain solution from e.g. a tray to the printing cylinder. The roll transferring has the benefit that the fountain solution is evenly distributed over the printing cylinder; whereas it has the disadvantage that dirt (e.g. ink) may be transferred from the printing cylinder to the tray containing the fountain solution, hence polluting the fountain solution.

Spraying the fountain solution onto the printing cylinder alleviates the problems with fountain solution pollution, but it is hard to get an as even distribution with a spraying device as it is with a roll transfer device.

A spraying device generally comprises a spray bar fitted with a number of controllable spray units; the spray bar contains means for supplying the spray units with fountain solution, electrical wiring for the control of the spray units, and in some cases pipes for supplying pressurized air to the units.

It is a generally conceived problem in the art of spray bars that the spray units have various performances regarding spraying density and spray rate. The differences regarding spray rates can be handled by individual control of each spray unit, but such control is very inconvenient, especially if the total spray rate of the spray assembly is to be altered. Moreover, should the spray distribution of a single unit differ from what is desired, this problem will not be addressed by individual control.

Today, it is necessary to individually check each spray unit and measure the spray rate and spray shape of each unit. Spray units having an inappropriate spray shape and/or spray rate are discarded. In some cases, up to 50 percent of the spray units are discarded since they do fulfill the criteria.

Usually, the spray units mounted on the spray bare are enclosed within some kind of housing; in some cases, such housing may be individual housings for each of the units, whereas in some cases a common housing encloses all units. Usually, the individual housings have the sole purpose of overcoming problems concerning dirt sticking to the spray units. In the case of common housings, there are examples of housings provided with screens adapted to block portions of the sprays from the units (see e.g. U.S. Pat. No. 5,299,495), but such blocking functions have hitherto not been used to suppress differences between spray units, rather to decrease the spray rate of the spray assembly; U.S. Pat. No. 5,299,495 is directed towards a device reducing the spray output from a given spray bar. Possible unit-to-unit variations are not decreased.

Moreover, since screens of U.S. Pat. No. 5,299,495 are provided on both an upper end and or a lower end of the spray, the spray portions impinging the upper portion will agglomerate and form droplets , which eventually will drop down from the upper screen and disturb the spray intended to pass the screen and impinge the printing cylinder to be moistened.

DE 26 58 875 A1 discloses an apparatus for producing a humidity fog for the cylinder humidification in offset rotary printing presses. The apparatus comprises spray nozzles emitting a spray which is converted into a fog, which subsequently is blown towards the cylinder using a fan.

However, a problem of the apparatus of DE 26 58 875 A1 is that large amount of spray fluid in the fog undesirably escapes to the ambient air. A further problem is that the apparatus is difficult to clean and maintain. Furthermore, the apparatus is complex and expensive.

### SUMMARY OF THE INVENTION

It is an object of the invention to alleviate, mitigate, and/or overcome the problems of prior art.

It is the object of the invention to provide a screen assembly and a method allowing for adjusting for unit-to-unit variations.

Furthermore, it is an object of the invention to provide a less complex humidification arrangement and method allowing for compensation of unit-to-unit variations.

According to the invention, these and other problems are solved, or at least alleviated by an individually formed screen surface configured to control the spray distribution by screening off spray portions from escaping the housing.

In order to minimize the amount of spray that is screened off from escaping the housing, spray units arranged to provide the spray may be flat spray units.

In order to minimize impact of spray interaction, the individually formed screen could be arranged in front of a crossing point for the sprays from the unit.

In an aspect of the invention an arrangement for controlling a spray distribution of a pulse width modulated spray dampener at a printing press is provided. The arrangement comprises a spray beam having a number of spray units. The arrangement further comprises a housing at least partly enclosing the spray units, wherein the housing is arranged such that at least a part of the sprays emitted from the spray units is screened off from escaping the housing by an individually formed screen surface configured to control the spray distribution by screening off a spray portion of the spray from escaping the housing. At least the spray portion not screened off is emitted from the spray units with a travelling velocity being higher than the surrounding air, through which said spray portion travels, until said spray portion hits a printing roll.

In one embodiment of the invention, the individually formed screen surface comprises a number of tongues arranged side by side, wherein the height of the tongues may be controlled to achieve the individually formed screen surface. Such an embodiment is advantageous in that it is uncomplicated and cost efficient.

In another embodiment, the individually formed screen surface is a plate comprising an individually formed edge. This embodiment is advantageous in that it is impossible to manipulate the spray distribution after the arrangement has been delivered.

Also, the above problems are solved by a method comprising the steps of:

a. mounting the spray beam in front of a printing roll;

b. mounting an individually formed screen between the spray beam and the printing roll, wherein the individually formed screen is configured to control the spray distribution by screening off a spray portion of the spray from escaping the housing,

c. controlling the spray units to emit a spray, whereof at least the spray portion not being screened off has a travelling velocity being higher than the surrounding air, through which said spray portion travels, until said spray portion hits the printing roll.

By mounting the spray beam in front of a measurement device capable of measuring a spray distribution and adjusting a variable screen, the spray distribution can be preset to provide any desired spray distribution.

By providing a fixed screen having the same shape as the variable screen giving the desired spray outline, the variable screen can be substituted by a corresponding fixed screen.

By mounting a variable screen on a position opposite the fixed screen, the spray distribution may be varied by varying the height of the tongues of the variable screen.

### BRIEF DESCRIPTION OF THE DRAWINGS

Hereinafter, the invention will be described with reference to the appended drawings, wherein:

FIG. 1 is a perspective view of a spray assembly provided with a variable screen according to a first embodiment of the present invention,

FIG. 2 is a schematic side view of a spray assembly provided with a variable screen according to the first embodiment of the present invention,

FIG. 3 is a schematic top view of a spray assembly mounted in front of a roller,

FIG. 4 is a schematic front view showing the variable screen of FIGS. 1 and 2,

FIG. 5 is a schematic front view of a fixed screen according to the present invention,

FIG. 6 is a schematic front view of a spray assembly provided with a variable screen according to the first embodiment of the present invention, FIG. 6 further showing interaction between the variable screen and sprays from the spray assembly,

### DESCRIPTION OF EMBODIMENTS

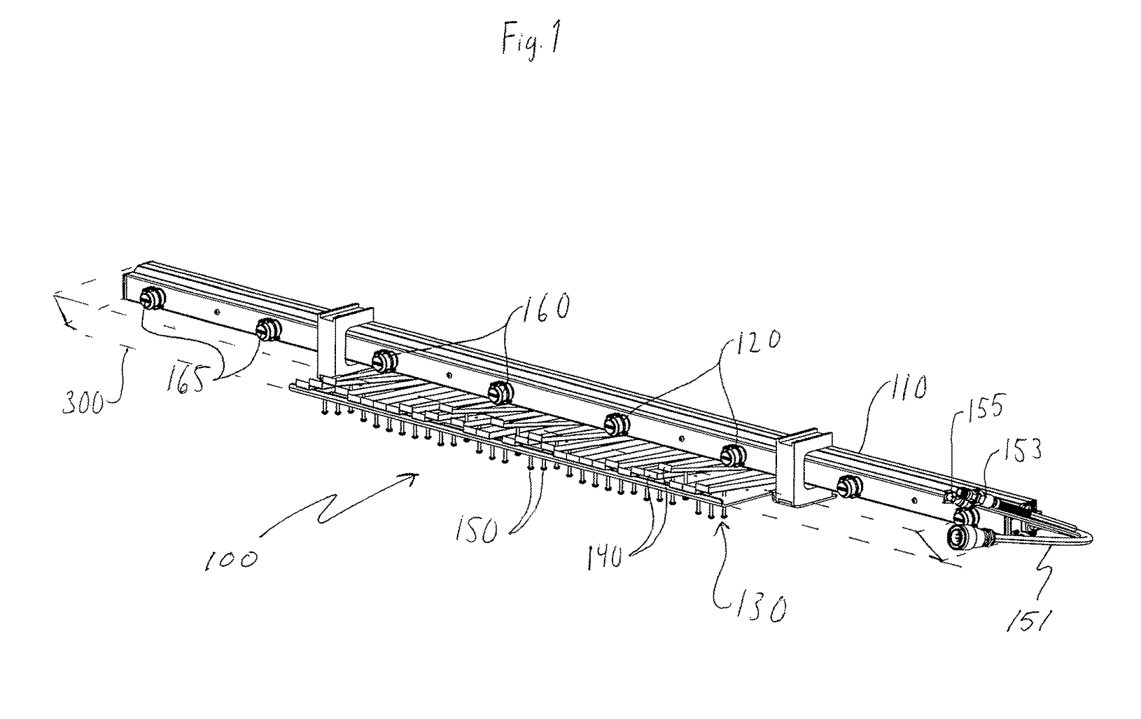

In FIG. 1, a part of a spray assembly 100 is shown. The spray assembly 100 comprises a spray beam 110, a number of spray units 120 and a housing 300 (schematically shown with dashed lines), which encloses the spray units and leaves an opening for the sprays from the spray units. Moreover, the spray assembly 100 comprises a variable screen 130, comprising a number of individually controllable tongues 140. In the shown embodiment, a height of the tongues 140 can be set by manipulating screws 150. By varying the heights of the tongues, an individually formed screen surface is formed.

Preferably, the spray units 120 are pulse width modulated flat spray units. Such units may be turned on/off in intervals, and by controlling those intervals, the spray rate may be controlled.

The spray beam 110 may contain supply hoses 151 supplying the units with fountain solution (i.e. the fluid ejected by the units), electrical wiring 153 for controlling the units, and optionally supply hoses 155 for supplying optional covers 160, comprising a slit 165, with a flow of pressurized air in order to keep the units clean from air-born contamination. Such covers are thoroughly described, e.g. in U.S. patent application Ser. No. 10/560,402.

With reference to FIG. 2, it is shown how the spray beam 110 with the units 120 is mounted in front of a printing cylinder 170. Sprays S are directed from the units 120 towards the printing cylinder 170. The variable screen 130 is mounted in the path of the spray S, preferably relatively close to the printing cylinder 170. As is evident from FIG. 2, the portion of the spray S that impinges the variable screen 130 will not hit the print cylinder 170. By varying the height of the tongues 140, the ratio of the spray S from the units that escapes the housing, i.e. hits the printing cylinder 170, may be varied; if the height is large, a large portion of the spray will not escape the housing, if the height is low, a larger portion (or all) of the spray will escape the housing, and ultimately hit the printing cylinder 170. Accordingly, utilizing the tongues 140 a portion of the spray emitted from each spray unit may be screened off

The spray assembly 100 does not require a fan to transport the spray from a spray unit to the printing cylinder, as is the case in DE 26 58 875 A1, which advantageously leads to a less complex construction, as well as heavily reduced amount of spray fluid escaping to the ambient air.

In an embodiment, each spray unit 120 is configured to emit a spray having a higher velocity than the surrounding air through which the spray travels, until the spray or at least part thereof hits the printing cylinder. In this way, the spray not screened off directly hits the printing cylinder, due to its velocity through the surrounding air. This solution is quite contrary to the solution of DE 26 58 875 A1 in which the spray fog travels with the air stream from the fan, thus the velocity of the fog being equal or less than the velocity of the air stream. Since the air stream must exit the apparatus of DE 26 58 875 A1, in conjunction with the fact that the spray fog is transported towards the printing cylinder by means of the air stream, due to conventional fluid mechanics, the air stream will flow past or around the printing cylinder towards the exit, resulting in that a large amount of spray fog leaves the apparatus not hitting the printing cylinder but instead escapes to the ambient air.

This problem is solved by the spray assembly 100 according to an embodiment, since the spray hitting the printing cylinder has a higher velocity than the surrounding air, whereby the spray will not flow past the printing cylinder but instead directly hit it.

Accordingly, in an embodiment, the spray is emitted from the spray units (120) with a travelling velocity being higher than the surrounding air, through which said spray portion travels, until said spray portion hits a printing cylinder (170).

Furthermore, the construction of the spray assembly 100 allows for facilitated cleaning and maintenance, since the spray units 120 and the screen portions 240 are easily accessible.

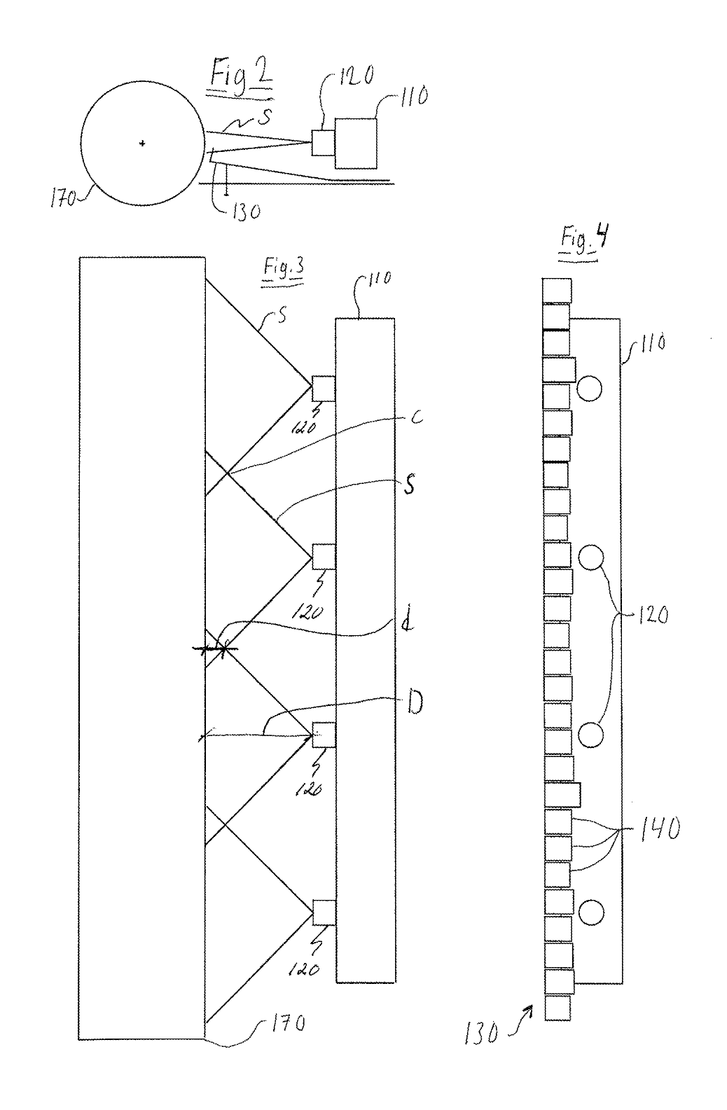

In FIG. 3, it is shown how the sprays S interact. As can be seen, the sprays S are formed in a triangular manner seen from above, an apex of the triangle being located close to the unit 120 for each of the sprays. The sprays S will start to interact with one another at a certain distance from the units 120. In FIG. 3, the points where the sprays S start to interact with one another are denoted C. A distance d represents the distance between the crossing points C and the printing cylinder, and a distance D represents the distance from the spray units 120 to the printing cylinder 170. In some embodiments of the invention, the distance d may be about 20-40 mm, whereas the distance D , may be about 74 to 132 mm.

By comparing FIGS. 2 and 3, it is clearly shown that the sprays S are of the flat spray type, since the spray is considerably wider than higher.

Preferably, but not necessarily, the variable screen 130 is located in front of the spray interaction points C, i.e. the variable screen 130 is located close to the printing cylinder 170 than the spray interaction points C.

In order to set the height of the tongues 140 of the variable screen 130, to get a uniform, or desired, spray outline, the spray beam 110, with units 120 and the housing, including the variable screen 130, may be placed in front of a measurement device (not shown). In its simplest form, such a measurement device may comprise a number of pipes fluidly connected to equally sized spray collection areas. The volume of spray collected by each spray collection area is gathered in the corresponding pipes, after which the spray rate over the length of the spray beam 110 can be determined

Should the spray rate be higher anywhere along any portion of the length of the spray beam, the height of the tongues 140 adjacent the portion can be increased accordingly.

By setting the height of the tongues 140, an even spray density over the entire length of the spray beam can be achieved.

In FIG. 4, it is shown how the variable screen 130 may be configured after the heights of the tongues have been set.

It is also possible to adjust the total spray rate of the spray beam; by increasing the height of all tongues, the total spray rate of the spray beam can be altered. Here, it should be noted that the spray rate not necessarily is linear. For example, a height increase of e.g. 1 mm of one tongue does not necessarily give the same change of spray rate as an equally large height increase of another tongue.

In the shown embodiment, ten tongues per unit are arranged in the variable screen; the height of the tongues 140 placed immediately in front of a specific unit will, of course, affect the amount of spray from that particular spray unit that is allowed to leave the housing, whereas tongues placed between two adjacent spray units will capture sprays from both adjacent units.

Tests have shown that it is sufficient to set the heights of the tongues once; the spray rates of the units do not change significantly over time. However, it is important not to interchange the units between one another if the units should be demounted from the spay beam, e.g. for cleaning Therefore, according to one embodiment of the present invention, each individual spray unit could be marked, for example with a number, a letter, or a combination thereof, which is representative for each units' intended position on the spray beam.

If a unit should break or reach a state of wear where it cannot longer be used, it must be replaced. Since it cannot be guaranteed that the new unit has the same spray characteristics as the replaced unit, it is advisable to carry out a resetting of the tongues.

If the risk of unit failure is considered as low, it might be possible to perform a spray beam setting (i.e. measure the spray rate of the spray beam according to what has been described above and adjust the heights of the tongues 140) on a factory, copy the heights of the tongues to e.g. a plate 200 (shown in FIG. 5), mount the plate 200 in a similar way as the variable screen 130 and deliver a calibrated spray beam assembly to the customer. The plate 200 is not provided with an exact copy of the heights of the variable screen 130; instead, the heights of the tongues have been smoothed out, e.g. by a spline interpolation. Smoothening of the height has the advantage that possible rapid local changes in spray rate will be smoothed out, and the drawback is that the spray rate may be slightly altered as compared with the preset heights of the tongues.

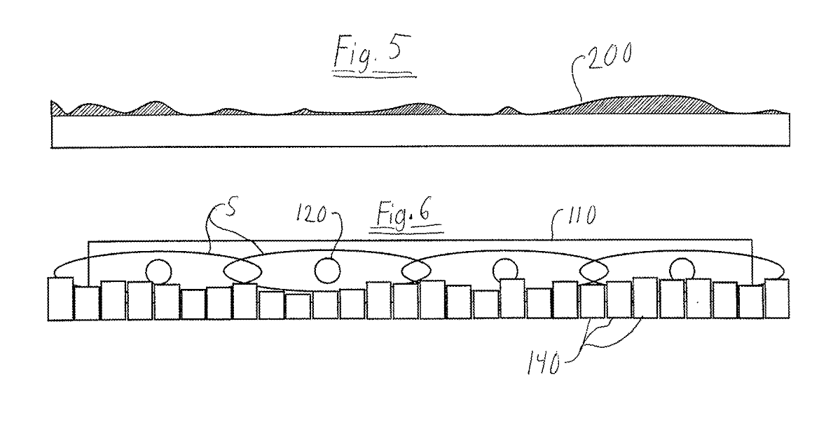

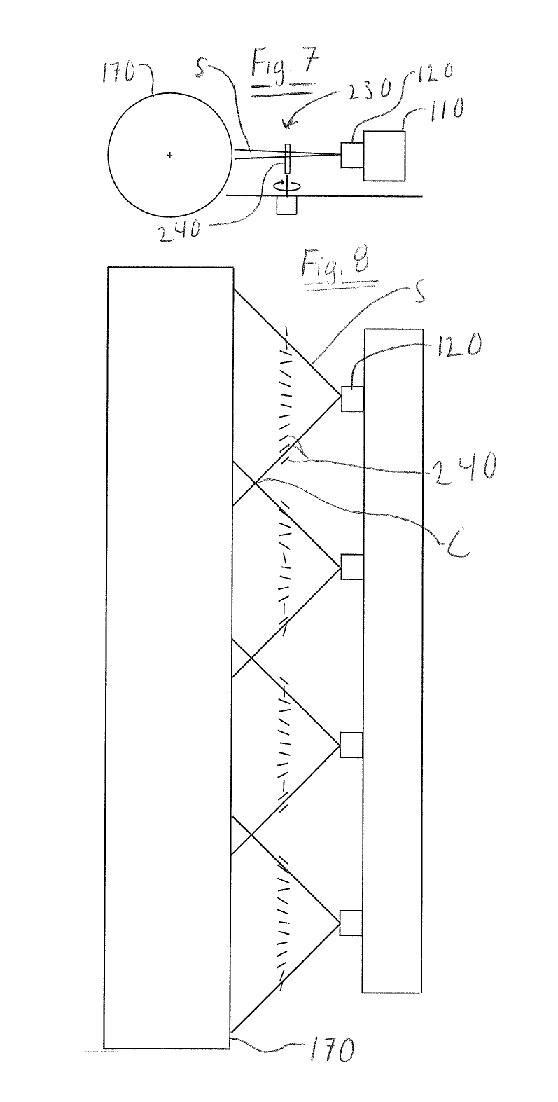

In FIG. 6, the interaction between sprays S and the variable screen 130 is shown in a front view, i.e. from the print cylinder 170.

Using a plate provided with an individually adapted upper edge has the advantage that unauthorized altering of the spray outline is avoided, and the drawback that exchange of a unit is more complicated.

Another benefit of the present invention is that it is possible to increase the spray density locally. This might be desired e.g. if one portion of the printing roller transfers more ink than other portions. On prior art spray assemblies, this could be achieved by modulating a pulse width to the spray units, i.e. allow a specific unit to eject more liquid than its neighbors. This is however a rather crude method for locally increasing the spray density.

Another embodiment of the invention is shown in FIG. 7. According to the embodiment of FIG. 7, a screen 230 comprises a number of rotatable screen portions 240. By rotating, i.e. setting an angle of, the screen portions 240, the ratio of spray that passes the screen portions 240 can be manipulated.

If a screen portion 240 is set such that a width of the screen portion is aligned with a straight line extending from the spray unit 120, only a small amount of the spray S will be caught on the screen portion, whereas if the screen portion is set such that the width of the screen portion extends perpendicularly to this line, a major portion of the spray S will be blocked from reaching the printing cylinder 170.

In FIG. 8, an exemplary setup of the screen portion 240 of the second embodiment is shown. Please note that the screen portions 240 are placed in front of the crossing points C, i.e. closer to the spray units 120. If the screen portions 240 would be placed closer to the printing cylinder 170, i.e. behind the crossing point C, it would be impossible to set screen portions placed in the sprays S from neighboring spray units 120 such that no spray impinges the screen portions.

In one embodiment of the present invention, the screen portions 240 are provided with openings, e.g. round holes or elongate openings. Provisions of such openings will reduce the screening effect of the screen portions, but will also even the spray, since a portion of the spray will pass through the screen portion.

A further embodiment of the present invention includes providing a variable screen according to any of the described embodiments, or and individually shaped plate, on both sides of the spray, i.e. both below the spray S and over the spray S. This embodiment has the advantage that the spray rate can be chosen within wider ranges, but it has the disadvantage that the spray portion that impinges the upper screen will agglomerate to form droplets, which will fall down through the spray and affect it.

1. An arrangement for controlling a spray distribution of a pulse width modulated spray dampener at a printing press, said arrangement comprising a spray beam having a number of spray units, and a housing at least partly enclosing the spray units wherein the housing is arranged such that at least a part of the sprays emitted from the spray units is screened off from escaping the housing by an individually formed screen surface configured to control the spray distribution by screening off a spray portion of the spray from escaping the housing, wherein the spray portion not screened off is emitted from the spray units with a travelling velocity being higher than the surrounding air, through which said spray portion travels, until said spray portion hits a printing roll.

2. The arrangement according to claim 1, wherein the spray units are flat spray units.

3. The arrangement according to claim 1, wherein the individually formed screen is arranged in front of a crossing point for the sprays from the spray units.

4. The arrangement according to claim 1, wherein the individually formed screen surface comprises a number of tongues arranged side by side, wherein the height of the tongues is controllable to achieve the individually formed screen surface.

5. The arrangement according to claim 1, wherein the individually formed screen surface is a plate comprising an individually formed edge.

6. Method for controlling a spray distribution of a pulse width modulated spray dampener at a printing press, said dampener comprising a spray beam having a number of spray units, and a housing at least partly enclosing the spray units, wherein the housing is arranged such that at least a part of the sprays emitted from the spray units is screened off from escaping the housing, comprising the steps of:
I. mounting the spray beam in front of a printing roll; and
II. mounting an individually formed screen between the spray beam and the printing roll, wherein the individually formed screen is configured to control the spray distribution by screening off a spray portion of the spray from escaping the housing,
III. controlling the spray units to emit a spray, whereof at least the spray portion not being screened off has a travelling velocity being higher than the surrounding air, through which said spray portion travels, until said spray portion hits the printing roll.

7. The method of claim 6, comprising the further step of:
IV. mounting the spray beam in front of a measurement device capable of measuring a spray distribution and
V. adjusting a variable screen such that a variable spray outline is achieved.

8. The method of claim 7, comprising the further step of:
VI. providing a fixed screen having the same shape as the variable screen giving the desired spray outline.

9. The method of claim 8, comprising the further step of:
VII. mounting the fixed screen in the position of the variable screen.

10. The method of claim 9, comprising the further step of
VIII. mounting a variable screen on a position opposite the fixed screen, such that the spray distribution may be varied by varying the height of the tongues of the variable screen.
